(19) United States
(12) Patent Application Publication
(10) Pub. No.: US 2014/0310053 A1
(43) Pub. Date: Oct. 16, 2014

(54) METHOD AND SYSTEMS FOR PROVIDING BUSINESS PROCESS SUGGESTIONS AND RECOMMENDATIONS UTILIZING A BUSINESS PROCESS MODELER

(71) Applicant: XEROX CORPORATION, Norwalk, CT (US)

(72) Inventors: Hua Liu, Fairport, NY (US); Changjun Wu, Rochester, NY (US); Frank Goetz, Fairport, NY (US); Arun Bakthavachalu, Webster, NY (US); Selvakumar Periasamy, Gowrivakkam (IN)

(73) Assignee: Xerox Corporation, Norwalk, CT (US)

(21) Appl. No.: 13/859,951

(22) Filed: Apr. 10, 2013

(51) Int. Cl. G06Q 10/06

(52) U.S. Cl. CPC G06Q 10/0633
USPC 705/7.27

(57) ABSTRACT

A system and method for providing a real-time business process suggestion and recommendation utilizing a business process modeler. A dynamic input from a business analyst can be incorporated utilizing a real-time suggestion engine. A real-time search can be performed by organizing a number of business processes in a tree structure where each leaf node represents a business process and each branch node represents a set of components that are shared by the business processes in a sub tree. A semantic execution path search can be performed to provide a real-time match between the partial business process and a catalogue of existing business processes by determining a constituent component and a score based on a reachability rule. The edges and/or components can be added and/or deleted to effectively organize the existing business processes based on previous suggestion to speed up a future suggestion.

### FIELD OF THE INVENTION

Embodiments are generally related to the field of business workflow management. Embodiments are also related to business process modeling techniques. Embodiments are additionally related to the provision of real-time business process suggestions and recommendations utilizing business process modelers.

### BACKGROUND

A business process and/or workflow can be a collection of related structured activities or tasks that produce a specific service or product (serve a particular goal) for a particular customer. Driven by the increasing demand in business agility and cost efficiency, many businesses are seeking ways to compose distributed services into the business processes. Business process modeling is a time consuming manual process, which typically requires a business analyst to spend a significant amount of effort and carry out multiple iterations to define efficient and effective business processes.

Business process catalogues permits the business analysts to search for existing business processes based on categories, keywords, providers, etc. Such approach assumes the existence of meta-data (e.g., tags, categories and etc.) that accurately describes the business processes, however, this assumption cannot be met in a real world scenario. In most cases, business analysts attempt several combinations of keywords to determine the business processes, which is not intuitive to them. Business analysts can benefit from real time suggestions of next steps and/or complete business processes during modeling.

For example, a business analyst may provide connected components and the system can then suggests similar business processes from the business process catalogue. The analyst can select one of the suggested processes. The analyst can continue adding more edge(s) and/or component(s) if the suggestion does not meet the requirement of the analyst. The system can dynamically adjust suggestions considering the newly provided information. Such real time suggestion assist the business analysts efficiently finish modeling by only providing partial information.

A business process modeler can be employed to display the next-step syntactic components statically as icons as shown in FIG. 1. Displaying very few static components does not assist in providing suggestions to the business analyst (irrespective of the analyst is a domain specialist or not) regarding the potential next service or set of services. Also, conventional business process modelers do not have the capability to display similar or recommended workflows for the newly completed workflow. Furthermore, it does not have the capability to display the recommended service for the created service.

Several conventional business process modelers have been developed to provide support for displaying the static syntactic components and act as a template which is a placeholder for creating new business process or update the existing business process. The limitation of the existing business modelers is that the business analyst needs to be a domain specialist to create the business process. Hence, it is not possible to create the unique business process complaint with the business standards unless and until the analyst is aware of the particular business function.

In one conventional approach, a web based business process modeling tool can be implemented on top of a web-based editor (e.g., an ORYX editor) which has a pre-defined syntactic component. The problem associated with such approach is that the business analyst needs to be a domain specialist to create the business model and the business model provides similar set of static suggestions for all the elements. Another conventional business process modeling tool changes the type of task by hovering over the element and chooses new task type. Such an approach does not suggest analyst regarding next potential service or element semantically rather it just lists all the syntactic elements available in the system. Also, the system does not provide similar workflows available in the system and the analyst must be an expert in business process modeling.

Based on the foregoing, it is believed that a need exists for an improved system and method for providing real-time business process suggestion and recommendation utilizing a business process modeler, as will be described in greater detailed herein.

### SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved business workflow management systems and methods.

It is another aspect of the disclosed embodiments to provide for an improved business process modeling techniques.

It is a further aspect of the disclosed embodiments to provide for an improved system and method for providing a real-time business process suggestion.

It is yet a further aspect of the disclosed embodiments to provide for an improved system and method for providing an interactive business recommendation utilizing a business process modeler.

The aforementioned aspects and other objectives and advantages can now be achieved as described herein. A system and method for providing a real-time business process suggestion and recommendation utilizing a business process modeler is disclosed herein. A dynamic input from a business analyst can be incorporated utilizing a real-time suggestion engine. A real-time search can be performed by organizing a number of business processes in a tree structure where each leaf node represents a business process and each branch node represents a set of components that are shared by the business processes in a sub tree. A semantic execution path search can be performed to provide a real-time match between the partial business process and a catalogue of existing business processes by determining a constituent component and a score based on a reachability rule. The edges and/or components can be added and/or deleted to effectively organize the existing business processes based on previous suggestion to speed up a future suggestion. A business process modeler can be configured with an auto-completion based recommendation to display a potential service with respect to the business process as an icon and an expansion recommendation to display a major component and a relative sequence in the business process while creating a workflow.

A constituent component in the partial business process can be determined and a most constituent component can be searched in the tree for the branch node(s). If no such node is found, the constituent component can be compared with all the direct children business processes of the root and the business processes that share components with the partial business processes can be returned. The constituent components can be marked for every business process in the sub tree of the branch node. The reachability rule can be extracted and compared with the partial business process to generate the score, where a higher score determines a better match. If the complete business process lacks one reachability rule, a pre-defined number can be added to the score. The list of business processes can be returned in an ascending order of the scores. The user can add and delete edges/components based on previous results, which can significantly improve the efficiency especially when the system possesses a large set of business processes in its repository.

The business process modeler can be customized to display the recommended services for the newly created workflow to achieve a complete end-to-end product. A registered service from a service composition platform can be employed to generate the next potential service. The registered service can be stored in a database and loaded in the business process modeler. Each service can be fetched from the database and can be created as a bean class before the service is loaded into the business process modeler. Internally, each class can be added and mapped based on heuristics so that a corresponding next service can be invoked based on a mapping value and displayed in the business process modeler when the business analyst select the service from the business modeler. Such auto completion feature saves enough time in business process creation.

An expansion recommendation link can be selected to provide suggestion for the created business process after completing the business process by dragging and dropping the required processes in the business modeler. The expansion based recommendation guides the business analyst to complete the business process and to identify the next set of services. The expansion recommendation functionality compares a mapping file which includes services that are available in the business process modeler. The mapping file can be created based on heuristics. The expansion recommendation also provides the recommended service as an alternative for a specific created service and similar workflow that exists in the repository.

### BRIEF DESCRIPTION OF THE FIGURES

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a GUI of a business process modeler;

FIG. 2 illustrates a schematic view of a computer system, in accordance with the disclosed embodiments;

FIG. 3 illustrates a schematic view of a software system including a business process suggestion and recommendation module, an operating system, and a user interface, in accordance with the disclosed embodiments;

FIG. 4 illustrates a block diagram of a business process suggestion and recommendation system, in accordance with the disclosed embodiments;

FIG. 5 illustrates a high level flow chart of operations illustrating logical operational steps of a method for providing a real-time business process suggestion, in accordance with the disclosed embodiments;

FIG. 6 illustrates a pseudo code for organizing a business process in a tree structure, in accordance with the disclosed embodiments;

FIGS. 7-8 illustrates a tree structure of a partial business process and two business processes, in accordance with the disclosed embodiments;

FIG. 9 illustrates a high level flow chart of operations illustrating logical operational steps of a method for providing an auto-completion based business process recommendation utilizing a business process modeler, in accordance with the disclosed embodiments;

FIGS. 10-11 illustrate a GUI of the business process modeler showing the auto-completion based business process recommendation, in accordance with the disclosed embodiments;

FIG. 12 illustrates a high level flow chart of operations illustrating logical operational steps of a method for providing an expansion based business process recommendation utilizing the business process modeler, in accordance with the disclosed embodiments; and

FIGS. 13-15 illustrate a GUI of the business process modeler showing the expansion based business process recommendation, in accordance with the disclosed embodiments.

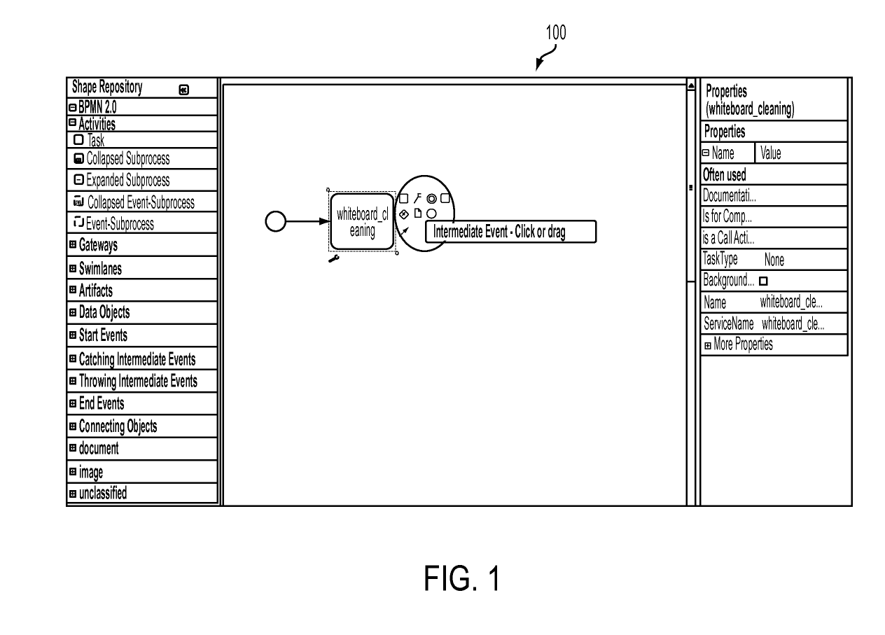

### DETAILED DESCRIPTION

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the present invention can be embodied as a method, data processing system, or computer program product. Accordingly, the present invention may take the form of an entire hardware embodiment, an entire software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, etc.

Computer program code for carrying out operations of the present invention may be written in an object oriented programming language (e.g., Java, C++, etc.). The computer program code, however, for carrying out operations of the present invention may also be written in conventional procedural programming languages such as the “C” programming language or in a visually oriented programming environment such as, for example, Visual Basic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., WiFi, Wimax, 802.xx, and cellular network or the connection may be made to an external computer via most third party supported networks (for example, through the Internet using an Internet Service Provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data processing apparatus to produce a machine such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

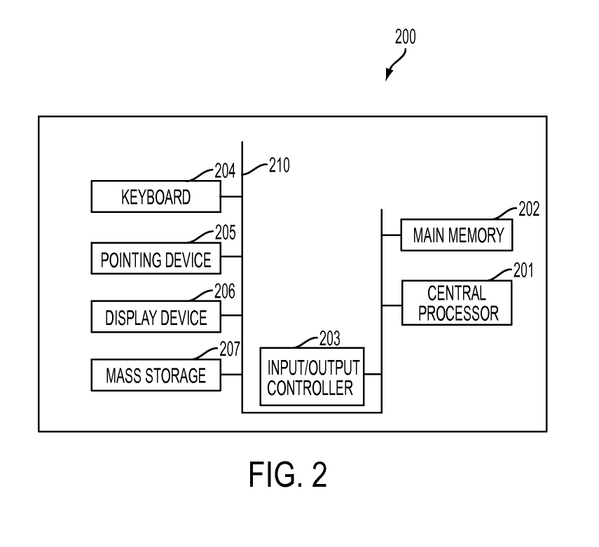

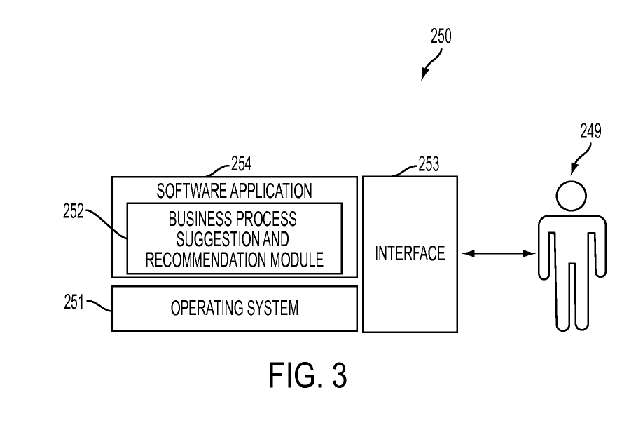

FIGS. 2-3 are provided as exemplary diagrams of data-processing environments in which embodiments of the present invention may be implemented. It should be appreciated that FIGS. 2-3 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 2, the disclosed embodiments may be implemented in the context of a data-processing system 200 that includes, for example, a central processor 201, a main memory 202, an input/output controller 203, a keyboard 204, an input device 205 (e.g., a pointing device such as a mouse, track ball, and pen device, etc.), a display device 206, a mass storage 207 (e.g., a hard disk), and a USB (Universal Serial Bus) peripheral connection. As illustrated, the various components of data-processing system 200 can communicate electronically through a system bus 210 or similar architecture. The system bus 210 may be, for example, a subsystem that transfers data between, for example, computer components within data-processing system 200 or to and from other data-processing devices, components, computers, etc.

FIG. 3 illustrates a computer software system 250 for directing the operation of the data-processing system 200 depicted in FIG. 2. Software application 254, stored in main memory 202 and on mass storage 207, generally includes a kernel or operating system 251 and a shell or interface 253. One or more application programs, such as software application 254, may be “loaded” (i.e., transferred from mass storage 207 into the main memory 202) for execution by the data-processing system 200. The data-processing system 200 receives user commands and data through user interface 253; these inputs may then be acted upon by the data-processing system 200 in accordance with instructions from operating system module 252 and/or software application 254.

The following discussion is intended to provide a brief, general description of suitable computing environments in which the system and method may be implemented. Although not required, the disclosed embodiments will be described in the general context of computer-executable instructions such as program modules being executed by a single computer. In most instances, a “module” constitutes a software application.

Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interlace, which lists the constants, data types, variable, and routines that can be accessed by other modules or routines, and an implementation, which is typically private (accessible only to that module) and which includes source code that actually implements the routines in the module. The term module may also simply refer to an application such as a computer program designed to assist in the performance of a specific task such as word processing, accounting, inventory management, etc.

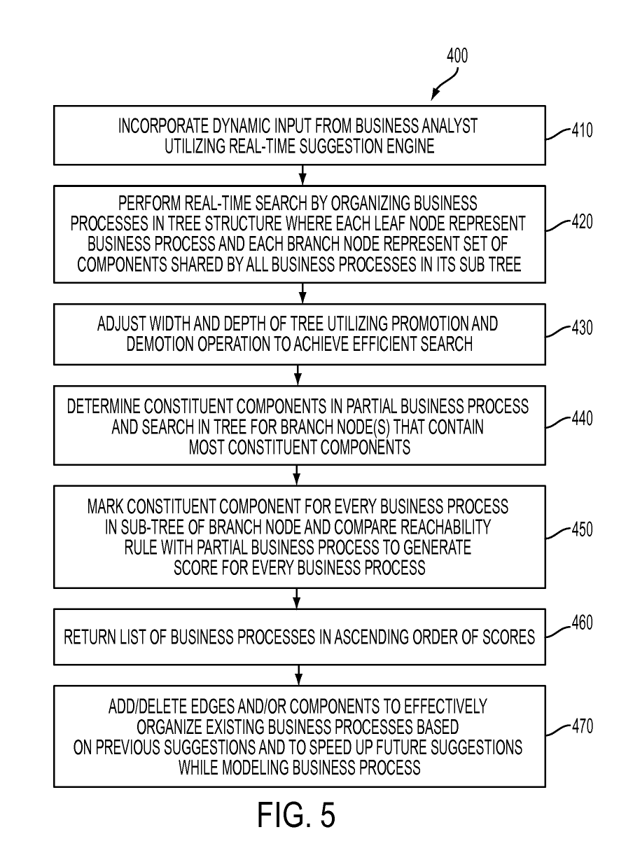

The interface 253, which is preferably a graphical user interface (GUI), also serves to display results, whereupon the user may supply additional inputs or terminate the session. In an embodiment, operating system 251 and interface 253 can be implemented in the context of a “Windows” system. It can be appreciated, of course, that other types of systems are possible. For example, rather than a traditional “Windows” system, other operation systems such as, for example, Linux may also be employed with respect to operating system 251 and interface 253. The software application 254 can include a business process suggestion and recommendation module 252 for providing a real-time business process suggestion and recommendation utilizing a business process modeler 385. Software application 254, on the other hand, can include instructions such as the various operations described herein with respect to the various components and modules described herein such as, for example, the method 400, 600, and 800 depicted in FIGS. 5, 9 and 12.

FIGS. 2-3 are thus intended as examples and not as architectural limitations of disclosed embodiments. Additionally, such embodiments are not limited to any particular application or computing or data-processing environment. Instead, those skilled in the art will appreciate that the disclosed approach may be advantageously applied to a variety of systems and application software. Moreover, the disclosed embodiments can be embodied on a variety of different computing platforms including Macintosh, UNIX, LINUX, and the like.

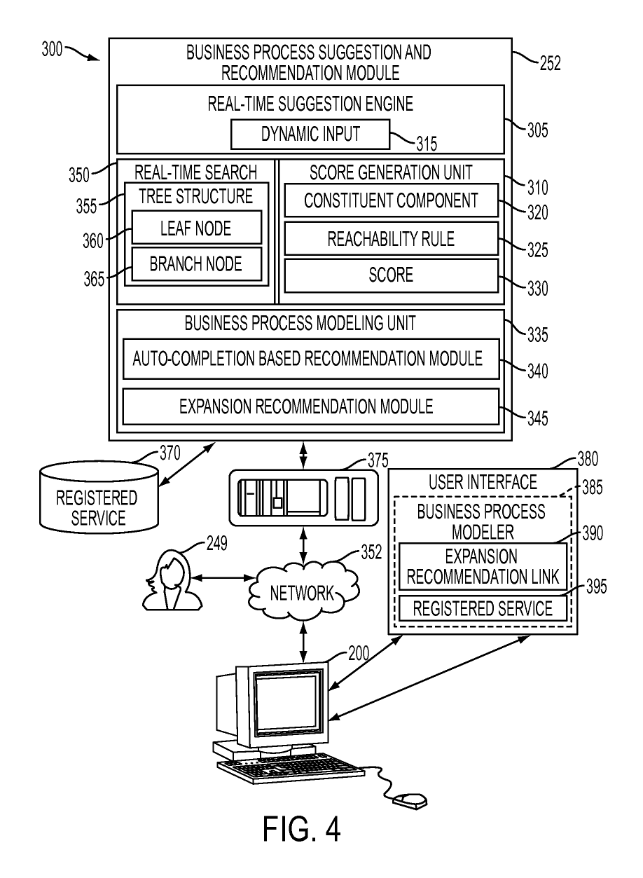

FIG. 4 illustrates a block diagram of a business process suggestion and recommendation system 300, in accordance with the disclosed embodiments. Note that in FIGS. 2-15, identical parts or elements are generally indicated by identical reference numerals. The business process suggestion and recommendation system 300 can be configured to include the business process suggestion and recommendation module 252 for providing a real-time business process suggestion and recommendation utilizing a business process modeler 385.

Business Process Modeling (BPM) in systems engineering is the activity of representing processes of an enterprise, so that the current process may be analyzed and improved. BPM is typically performed by business analysts and managers who are seeking to improve process efficiency and quality. The business process suggestion and recommendation module 252 provides a real-time match between the partial business process and a catalogue of existing business processes. The system 300 further includes a real-time engine 305, a score generation unit 310, and a business process modeling unit 335 connected to the data-processing system 200 via a network 352.

Note that the network 352 may employ any network topology, transmission medium, or network protocol. The network 352 may include connections such as wire, wireless communication links, or fiber optic cables. Network 352 can also be an Internet representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational, and other computer systems that route data and messages.

The real-time engine 305 incorporates a dynamic input 315 from a business analyst 249. A real-time search 350 can be performed by organizing a number of business processes in a tree structure 355 where each leaf node 360 represents a business process and each branch node 365 represents a set of components that are shared by the business processes in a sub tree. The score generation unit 310 marks a constituent component 320 and extracts and compares a reachability rule 325 with the partial business process to generate a score 330 for every business process. The score generation unit searches the branch node(s) 365 that includes a most constituent component 320 in the tree 355. If no such node is found, the constituent components 320 in the partial business can be compared with all direct children business processes of the root and the business processes that share components with the partial business processes can be returned.

If a complete business process lacks one reachability rule 325, a pre-defined number can be added to the score 330. The score generation unit 310 returns the list of business processes in an ascending order of the scores 330. The score generation unit 310 modifies the scores 330 of the business processes when the user adds more edge(s) and if it adds new reachability rule(s) 325 to the partial business process. The user can add and delete more components based on previous results, which can significantly improve the efficiency especially when the system 300 possesses a large set of business processes in its repository. The business process modeling unit 335 can be configured to include an auto-completion based recommendation module 340 and an expansion recommendation module 345. The auto-completion based recommendation module 340 displays a potential service with respect to the business process as an icon and the expansion recommendation module 345 displays a major component and a relative sequence in the business process while creating a workflow.

FIG. 5 illustrates a high level flow chart of operations illustrating logical operational steps of a method 400 for providing a real-time business process suggestion, in accordance with the disclosed embodiments. Initially, as indicated at block 410, the dynamic input 315 from the business analyst 249 can be incorporated utilizing the real-time suggestion engine 305. The real-time search 350 can be performed by organizing the business processes in the tree structure 355 where each leaf node 360 represent business process and each branch node 365 represent set of components shared by all business processes in its sub tree, as shown at block 420.

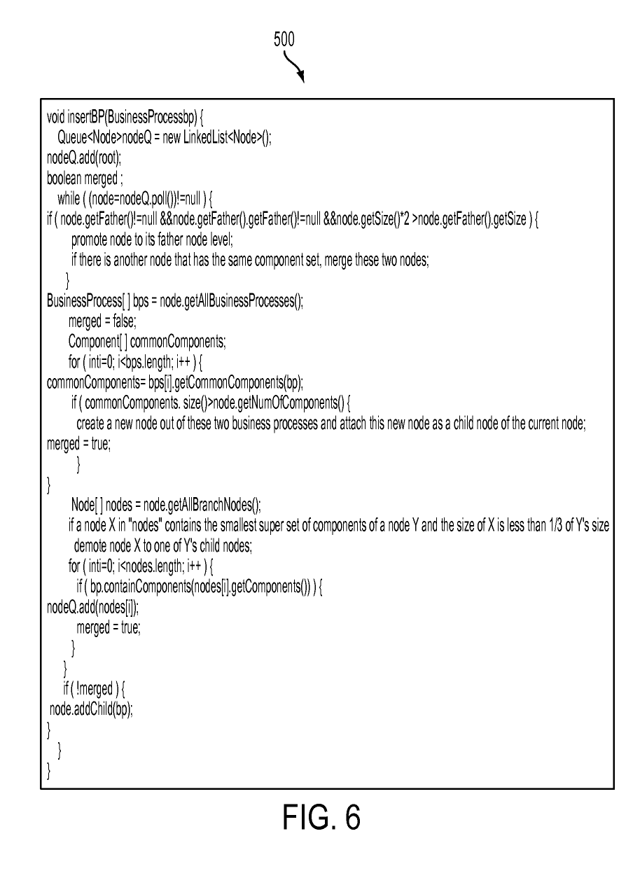

FIG. 6 illustrates a pseudo code 500 for organizing the business process in the tree structure 355, in accordance with the disclosed embodiments. For example, when a new business process BPi is inserted, the steps described in the pseudo code 500 can be performed. The width and depth of the tree 355 can be adjusted utilizing a promotion and demotion operation to achieve efficient search, as illustrated at block 430.

The constituent components 320 in the partial business process can be determined and search in the tree 355 for the branch node(s) 365 that contain the most constituent components 320, as shown at block 440. If no such node is found, compare with all the direct children business processes of the root and return the business processes that share components with this partial business processes. The business processes in the sub trees of the branch node(s) 365 can be obtained for every business process. The constituent components 320 can be marked and their reachability rules 325 can be extracted and compared with the partial business process to generate the score 330, where a higher score means a better match, as indicated at block 450.

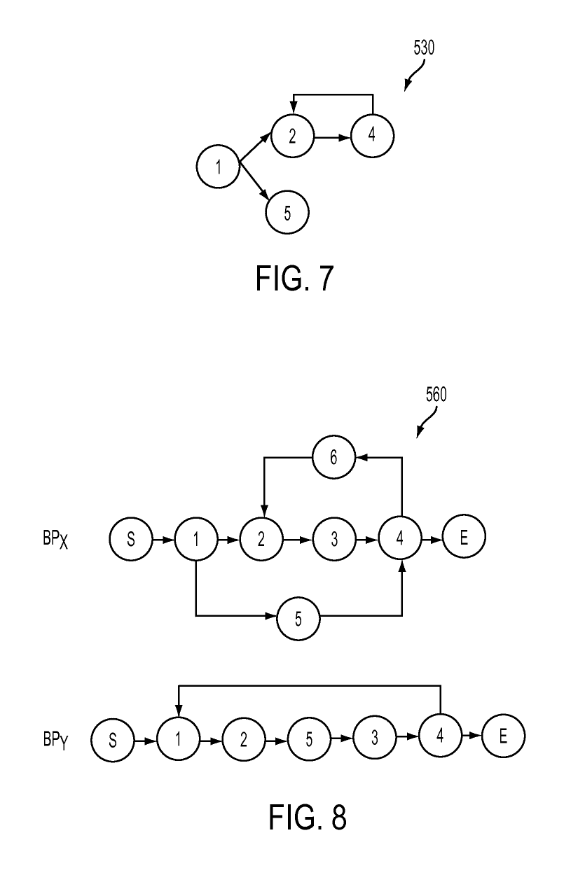

FIGS. 7-8 illustrate a tree structure of a partial business process 530 and two business processes 560, in accordance with the disclosed embodiments. For example, the partial business process 530 shown in FIG. 7 can be described utilizing the following rules. X->Y denotes that X can reach Y. The score associated with X->Y (L_{X->Y}) can be calculated as the shortest path from X to Y as shown below in equation (1).

1->2:1; 1->5:1; 1->4:2

2->4:1

4->2:1 (1)

Suppose the system 300 determines two candidate business processes 560 as shown in FIG. 8, BPₓ is described utilizing the following rules:

1->2:1; 1->5:1; 1->4:2

2->4:2

4->2:2 (2)

and BP_{y} can be described in the following rules.

1->2:1; 1->5:2; 1->4:4

2->4:3

4->2:2 (3)

The score can be calculated as Σ_{k1εn, k2εm}|L_{i,(k1,k2)}−L_{j(k1,k2)}|, where L_{i,(k1,k2)} represents the shortest path of k1->k2 in the partial business process and L_{j,(k1,k2)} represents the shortest path of k1->k2 in one complete business process. The score of BPₓ is 2 and the score of BPₓ is 6. If a complete business process lacks one reachability rule 325 (for example, it does not have x->y), a pre-defined number can be added to the score. Thereafter, as shown at block 460, the list of business processes can be returned in ascending order of scores 330. As a result, BPx ranks higher than BPy in the return list.

The existing business processes can be effectively organized and built on previous suggestions to speed up future suggestions while modeling business process by adding/deleting edges and/or components, as illustrated at block 470. For example, when the user adds more edge(s) and if it adds new reachability rule(s) 325 to the partial business process, modify the scores 330 of the business processes as shown at block 460. When the user adds more component(s), start from the branch node(s) identified in block 440 and repeat steps from block 440 to 460. When the user delete component(s), traverse back from the current branch node(s) identified in block 440 to the new branch node and then repeat step in block 450 and 460.

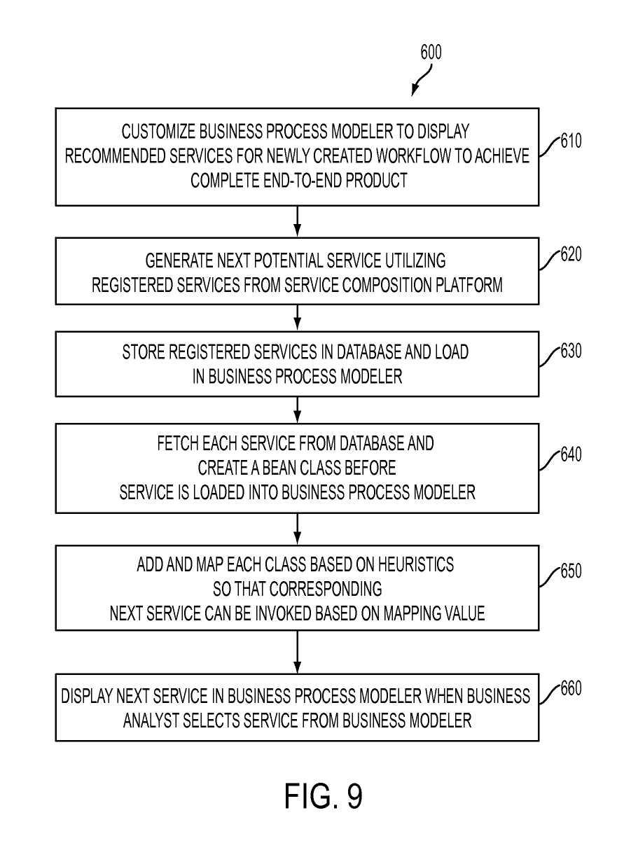

FIG. 9 illustrates a high level flow chart of operations illustrating logical operational steps of a method 600 for providing an auto-completion based business process recommendation utilizing a business process modeler 385, in accordance with the disclosed embodiments. Initially, as indicated at block 610, the business process modeler 385 can be customized to display recommended services for newly created workflow to achieve complete end-to-end product. The registered services 395 from a service composition platform can be employed to generate the next potential service, as shown at block 620. The registered services 395 can be stored in the database 370 and are loaded in the business process modeler 385, as shown at block 630. Each service can be fetched from the database 370 and is created as a bean class <servicename>Factory class before the service is loaded into the business process modeler 385, as illustrated at block 640.

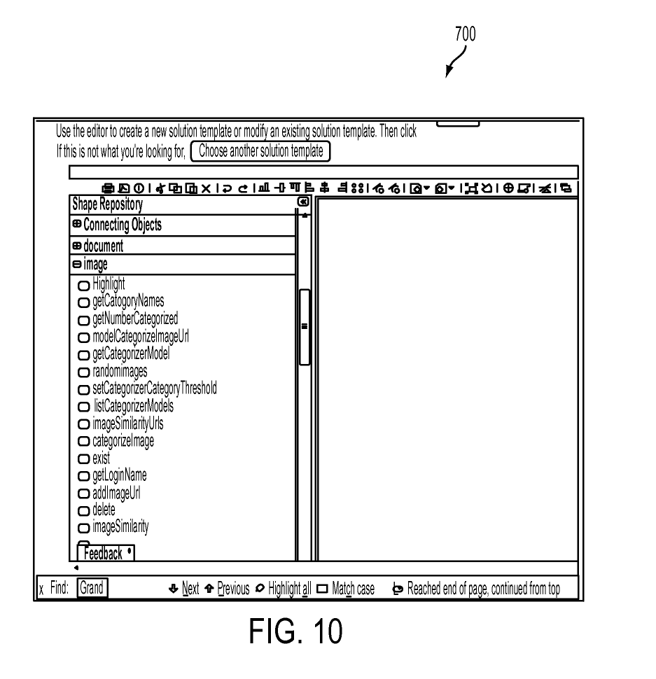

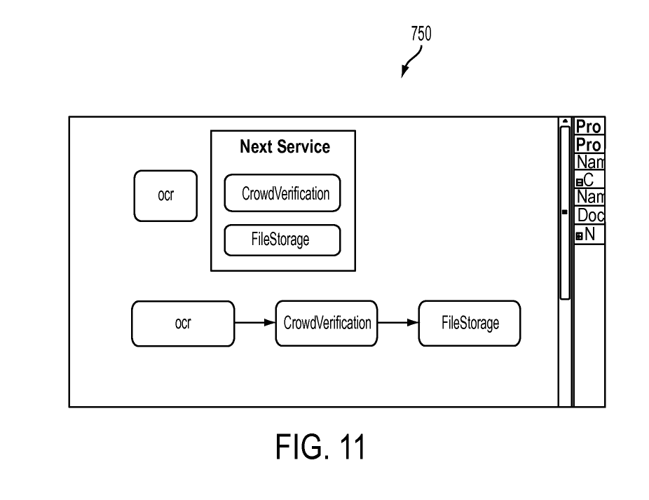

FIG. 10 illustrates the registered service 395 loaded in the business process modeler 385. Internally, each ServiceFactoy class can be added and mapped based on heuristics so that whenever the business analyst 249 select the service from the business modeler 385, the corresponding next service is invoked based on the mapping value and displayed in the business process modeler 385, as shown at block 650. For example, if the business analyst 249 starts creating the new workflow and select ocr, the business process modeler 385 with the help of auto-completion functionality provides the next available set of applicable services as shown in FIG. 11.

The next potential services for ‘ocr’ can be displayed in the business process modeler 750, as indicated at block 660. When the analyst selects CrowdVerification followed by fileStorage, the diagram can be represented as mentioned in FIG. 11 (just beneath ocr). With the help of auto complete feature, the business analyst 249 does not need to be a domain expert to create the business process. The business process modeler 750 saves enough time in business process creation and assists the business analyst 249 to choose the next potential service that is related to the domain specific business processes and guide to complete the solution.

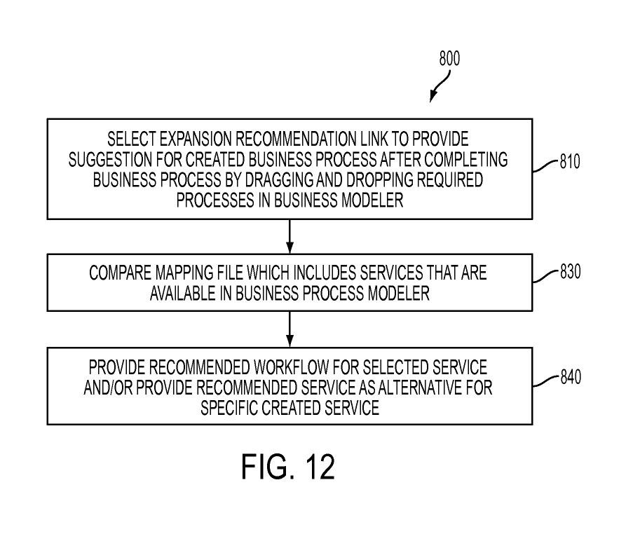

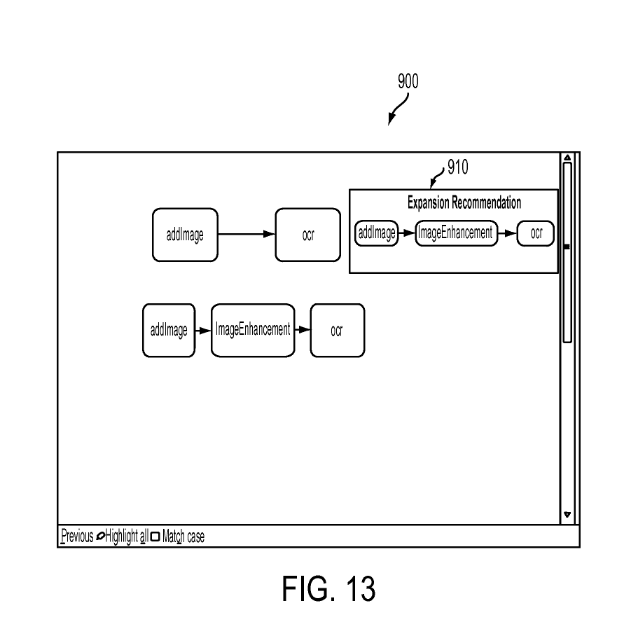

FIG. 12 illustrates a high level flow chart of operations illustrating logical operational steps of a method 800 for providing an expansion based business process recommendation utilizing the business process modeler 385, in accordance with the disclosed embodiments. The expansion recommendation link 390 that provides suggestion for the created business process can be chosen by the business analyst 249 after completing the business process by dragging and dropping the required processes in the business modeler, as shown at block 810. FIG. 13 illustrates a GUI 900 of the business process modeler 385 showing the expansion based business process recommendation, in accordance with the disclosed embodiments. The expansion recommendation 910 indicates that the created service (addImage and ocr) can be replaced with an alternate service and/or a new service (addImage, ImageEnhancement, ocr) and can be picked up from the suggested next services. Upon selecting the suggested service, the business process gets modified as shown in FIG. 13.

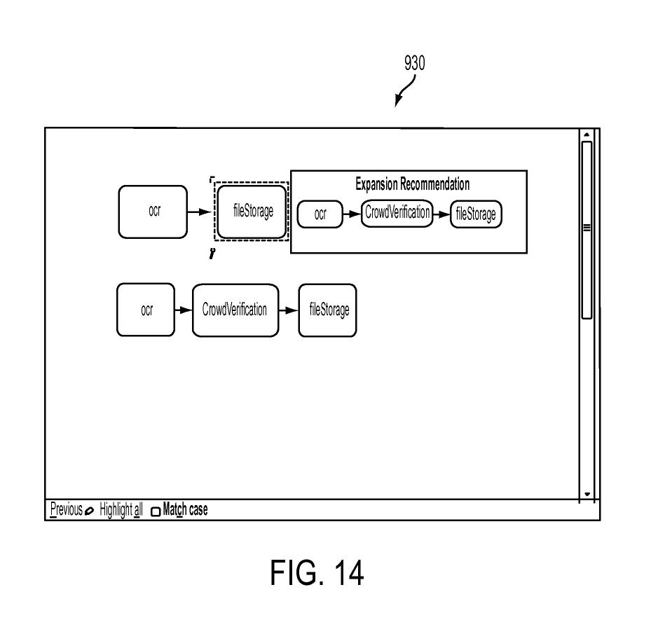

The expansion based recommendation unit guides the business analyst 249 to complete the business process to identify the next set of services or similar workflow. The analyst selects each required service from the business process modeler 385 and completes the workflow. For example, the analyst can select OCR and FileStorage, as depicted in FIG. 14. Once the workflow is completed, the expansion recommendation link 390 can be triggered. The expansion recommendation functionality compares the mapping file which consists of all the services that are available in the business process modeler 385, as illustrated at block 820.

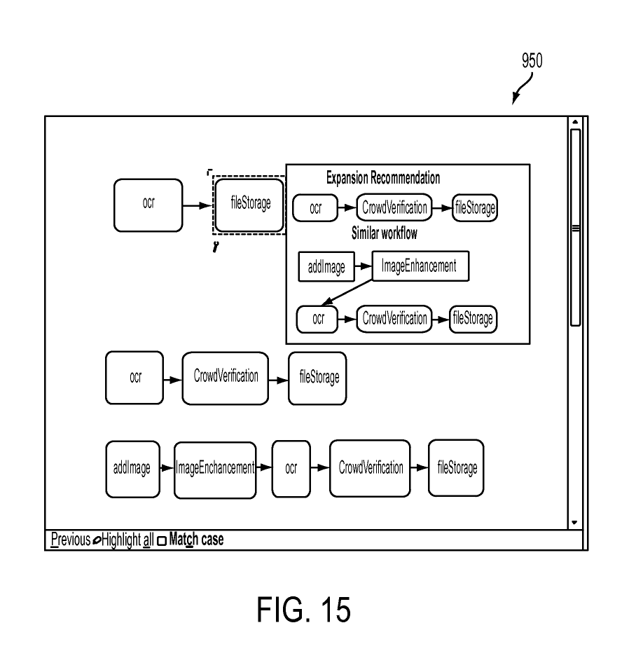

Each service includes the mapping and is created based on heuristics. The mapping file can be compared for each created service which then provides the recommended workflow for the selected services. The recommended service can also be provided as an alternative for the specific created service, as shown at block 830. For example, in FIG. 14, once the analyst selects the expansion recommendation, the previously created workflow (e.g., ocr, fileStorage) can be removed. The expansion recommendation also provides the similar workflow that exists in the repository in the expansion recommendation section, as shown in FIG. 15. The recommended workflow for the newly completed workflow is always considered as the best potential solution as the mapping of service is created by the domain experts.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A method for automatically providing business process suggestions and recommendations, said method comprising:
organizing a plurality of business processes in a tree structure, wherein each leaf node of said tree structure represents a business process and each branch node of said tree structure represents a set of components shared by said plurality of business processes in a sub tree of said tree structure;
performing a semantic execution path search of said tree structure to provide a real-time match between a partial business process and said plurality of business processes by determining a constituent component and a score based on a reachability rule; and
configuring a business process modeler with an auto-completion based recommendation to display a potential service with respect to said business process as an icon and an expansion recommendation to display a major component and a relative sequence in said business process while creating a workflow.

2. The method of claim 1 further comprising incorporating a dynamic input from a business analyst utilizing a real-time suggestion engine.

3. The method of claim 1 further comprising:
determining said constituent component in said partial business process and thereafter search a most constituent component in said tree for a branch node; and
comparing said constituent component with a direct children business process of a root and returning said business processes that share said constituent component with said partial business processes if said branch node is not found.

4. The method of claim 1 further comprising:
marking said constituent component for every business process in said sub tree of said branch node;
extracting and comparing said reachability rule with said partial business process to generate said score wherein a higher score determines a better match; and
adding a pre-defined number to said score if said business process lacks said reachability rule and returning said business process in an ascending order of said score.

5. The method of claim 1 further comprising adding and/or deleting said edge and said component to efficiently organize said business process based on a previous suggestion to speed up a future suggestion while a user is modeling said business process.

6. The method of claim 1 wherein said auto-completion based recommendation, further comprises:
generating a next potential service utilizing a registered service from a service composition platform;
storing said registered service in a database and loading in said business process modeler; and
fetching each service from said database and created as a bean class before said service is loaded into said business process modeler.

7. The method of claim 6 further comprising:
internally adding and mapping each class based on heuristics so that a corresponding next service is invoked based on a mapping value; and
displaying said service in said business process modeler when said business analyst select said service from said business modeler to save enough time in said business process creation.

8. The method of claim 1 wherein said expansion recommendation, further comprises:
dragging and dropping a required process in said business modeler and selecting an expansion recommendation link to provide suggestion for said created business process;
guiding said business analyst to complete said business process and to identify a next set of services; and
comparing a mapping file which includes said service that are available in said business process modeler wherein said mapping file is created based on heuristics.

9. The method of claim 8 further comprising providing a recommended service as an alternative for a specific created service and similar workflow that exists in said database.

10. A system for automatically providing business process suggestions and recommendations, said system comprising:
a processor;
a data bus coupled to said processor; and
a computer-usable medium embodying computer program code, said computer-usable medium being coupled to said data bus, said computer program code comprising instructions executable by said processor and configured for:
organizing a plurality of business processes in a tree structure, wherein each leaf node of said tree structure represents a business process and each branch node of said tree structure represents a set of components shared by said plurality of business processes in a sub tree of said tree structure;
performing a semantic execution path search of said tree structure to provide a real-Lime match between a partial business process and said plurality of business processes by determining a constituent component and a score based on a reachability rule; and
providing a business process modeler with an auto-completion based recommendation to display a potential service with respect to said business process as an icon and an expansion recommendation to display a major component and a relative sequence in said business process while creating a workflow.

11. The system of claim 10 wherein said instructions are further configured for incorporating a dynamic input from a business analyst utilizing a real-time suggestion engine.

12. The system of claim 10 wherein said instructions are further configured for:
determining said constituent component in said partial business process and thereafter search a most constituent component in said tree for a branch node; and
comparing said constituent component with a direct children business process of a root and returning said business processes that share said constituent component with said partial business processes if said branch node is not found.

13. The system of claim 10 wherein said instructions are further configured for:
marking said constituent component for every business process in said sub tree of said branch node;
extracting and comparing said reachability rule with said partial business process to generate said score wherein a higher score determines a better match; and
adding a pre-defined number to said score if said business process lacks said reachability rule and returning said business process in an ascending order of said score.

14. The system of claim 10 wherein said instructions are further configured for adding and/or deleting said edge and said component to efficiently organize said business process based on a previous suggestion to speed up a future suggestion while a user is modeling said business process.

15. The system of claim 10 wherein said instructions are further configured for providing said auto-completion based recommendation by:
generating a next potential service utilizing a registered service from a service composition platform;
storing said registered service in a database and loading in said business process modeler; and
fetching each service from said database and created as a bean class before said service is loaded into said business process modeler.

16. The system of claim 10 wherein said instructions are further configured for:
internally adding and mapping each class based on heuristics so that a corresponding next service is invoked based on a mapping value; and
displaying said service in said business process modeler when said business analyst select said service from said business modeler to save enough time in said business process creation.

17. The system of claim 10 wherein said instructions are further configured for providing said expansion recommendation by:
dragging and dropping a required process in said business modeler and selecting an expansion recommendation link to provide suggestion for said created business process;
guiding said business analyst to complete said business process and to identify a next set of services; and
comparing a mapping file which includes said service that are available in said business process modeler wherein said mapping file is created based on heuristics.

18. The system of claim 17 wherein said instructions are further configured for providing a recommended service as an alternative for a specific created service and similar workflow that exists in said database.

19. A processor-readable medium storing computer code representing instructions to cause a process for providing business process suggestions and recommendations, said computer code comprising code to:
organize a plurality of business processes in a tree structure, wherein each leaf node of said tree structure represents a business process and each branch node of said tree structure represents a set of components shared by said plurality of business processes in a sub tree of said tree structure;
perform a semantic execution path search of said tree structure to provide a real-time match between a partial business process and said plurality of business processes by determining a constituent component and a score based on a reachability rule; and
configure a business process modeler with an auto-completion based recommendation to display a potential service with respect to said business process as an icon and an expansion recommendation to display a major component and a relative sequence in said business process while creating a workflow.

20. The processor-readable medium of claim 19 wherein said code further comprises code to incorporate a dynamic input from a business analyst utilizing a real-time suggestion engine.
